(19) United States
(12) Patent Application Publication
(10) Pub. No.: US 2025/0259426 A1
(43) Pub. Date: Aug. 14, 2025

(54) IMAGE PROCESSING APPARATUS AND CONTROL METHOD THEREOF, IMAGE CAPTURING APPARATUS, AND STORAGE MEDIUM

(71) Applicant: CANON KABUSHIKI KAISHA, Tokyo (JP)

(72) Inventor: Yasuhiko IWAMOTO, Tokyo (JP)

(21) Appl. No.: 19/195,824

(22) Filed: May 1, 2025

Related U.S. Application Data
(63) Continuation of application No. PCT/JP2023/035350, filed on Sep. 28, 2023.

(30) Foreign Application Priority Data
Nov. 25, 2022 (JP) 2022-188698

(51) Int. Cl. G06V 10/774; G06V 10/40; G06V 10/764; G06V 10/77

(52) U.S. Cl. CPC G06V 10/774; G06V 10/40; G06V 10/764; G06V 10/7715

(57) ABSTRACT

This image processing device: acquires a dictionary obtained by machine learning, and a plurality of learning images used for the machine learning of the dictionary; selects, from among the acquired plurality of learning images, one or more learning images to be used as information indicating characteristics of the dictionary; and generates linking information that link the selected one or more learning images with the dictionary.

### CROSS-REFERENCE TO RELATED APPLICATIONS

This application is a Continuation of International Patent Application No. PCT/JP2023/035350, filed Sep. 28, 2023, which claims the benefit of Japanese Patent Application No. 2022-188698, filed Nov. 25, 2022, both of which are hereby incorporated by reference herein in their entirety.

### BACKGROUND

### Field of the Technology

The present disclosure relates to an image processing apparatus and a control method thereof, an image capturing apparatus, and a storage medium.

### Description of the Related Art

Cameras equipped with dictionaries prepared by the manufacturer in advance through machine learning (“ML dictionaries” hereinafter) are being sold. With this type of camera, using the ML dictionary makes it possible to detect various objects, such as people, dogs, horses, and the like, from images that have been shot. As machine learning technology has become more widespread, using a plurality of ML dictionaries in cameras has also been proposed. As a configuration that uses a plurality of ML dictionaries, Patent Literature (PTL) 1 discloses switching among a plurality of ML dictionaries on the basis of past results of detecting continuous images using the ML dictionaries. Additionally, PTL 2 discloses analyzing a detection result from each of a plurality of ML dictionaries, and changing an analysis time for which detection is to be performed using each respective ML dictionary in accordance with the accuracy of each result.

### CITATION LIST

### Patent Literature

PTL 1: Japanese Patent Laid-Open No. 2021-132369
PTL 2: Japanese Patent Laid-Open No. 2022-039667

### Non Patent Literature

NPL 1: S. Haykin, “Neural Networks A Comprehensive Foundation 2nd Edition”, Prentice Hall, pp. 156-255, July 1998 (referenced in the embodiments)

However, these documents do not consider situations where a user selects and uses a preferred ML dictionary from a plurality of ML dictionaries installed in the camera to suit that user's purposes. When a user selects a preferred dictionary from a plurality of ML dictionaries, it is desirable for the user to be able to understand the characteristics of the selected ML dictionary in advance. For example, even among ML dictionaries capable of detecting horses, it is conceivable that a plurality of the ML dictionaries will have different characteristics, such as one ML dictionary being suited to detecting special postures, another ML dictionary being suited to detecting similar species such as zebras, and the like. A method for expressing the performance of an ML dictionary has not yet been proposed, and when a user selects one of a plurality of ML dictionaries to use, it may be difficult for the user to understand the characteristics of the ML dictionary in advance.

### SUMMARY

One aspect of the present disclosure provides a configuration capable of generating information enabling a user to understand the characteristics of a dictionary obtained through machine learning.

An image processing apparatus according to one aspect of the present disclosure has the following configuration. In other words, the image processing apparatus includes: obtaining means for obtaining a dictionary obtained through machine learning and a plurality of training images used in the machine learning of the dictionary; selecting means for selecting, from the plurality of training images, at least one training image to be used as information expressing a characteristic of the dictionary; and generating means for generating association information that associates the at least one training image selected by the selecting means with the dictionary.

Features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain principles of the disclosure.

FIG. 1A is a block diagram illustrating an image capturing apparatus according to a first embodiment.

FIG. 1B is a block diagram illustrating an example of the functional configuration of a dictionary switching unit in the image capturing apparatus.

FIG. 2 is a schematic diagram illustrating an example of the configuration of a CNN in an object detection unit of the first embodiment.

FIG. 3 is a schematic diagram illustrating an example of part of the configuration of the CNN according to the first embodiment.

FIG. 4 is a schematic diagram illustrating an example of the configuration of a CNN in an object categorization unit of the first embodiment.

FIG. 5 is a flowchart illustrating ML dictionary switching processing according to the first embodiment.

FIG. 6 is a flowchart illustrating association information generation processing according to the first embodiment.

FIG. 7A is a flowchart illustrating target image selection processing according to the first embodiment.

FIG. 7B is a flowchart illustrating target image selection processing according to the first embodiment.

FIG. 8A is a schematic diagram illustrating an example of the display of a dictionary characteristic expression according to the first embodiment.

FIG. 8B is a schematic diagram illustrating an example of the display of a dictionary characteristic expression according to the first embodiment.

FIG. 9 is a flowchart illustrating target image selection processing according to a second embodiment.

FIG. 10 is a flowchart illustrating association information generation processing according to a third embodiment.

FIG. 11 is a diagram illustrating an example of an object categorization result according to the third embodiment.

FIG. 12 is a flowchart illustrating target image selection processing according to the third embodiment.

FIG. 13A is a schematic diagram illustrating an example of the display of a dictionary characteristic expression according to the third embodiment.

FIG. 13B is a schematic diagram illustrating an example of the display of a dictionary characteristic expression according to the third embodiment.

FIG. 14 is a block diagram illustrating an example of the configuration of an image processing system according to a fourth embodiment.

FIG. 15 is a block diagram illustrating an example of the configuration of a cloud system according to a fourth embodiment.

FIG. 16A is a flowchart illustrating processing according to the fourth embodiment.

FIG. 16B is a flowchart illustrating processing according to the fourth embodiment.

FIG. 16C is a flowchart illustrating processing according to the fourth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### (Configuration of Image Capturing Apparatus)

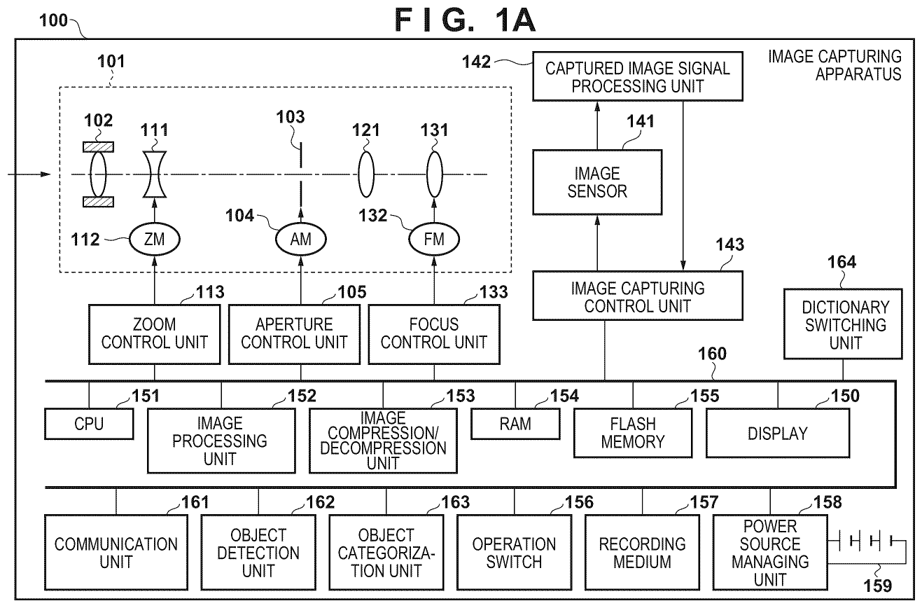

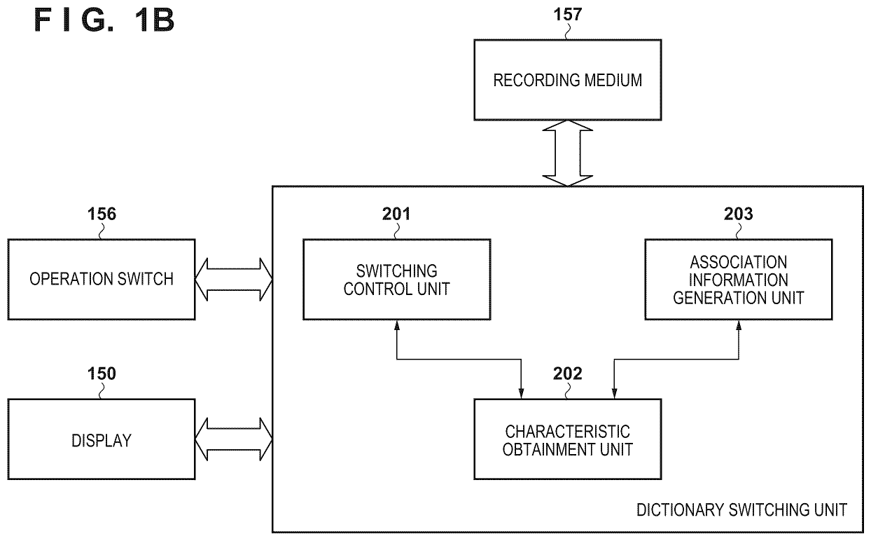

FIG. 1A is a block diagram illustrating an example of the configuration of an image capturing apparatus 100 according to a first embodiment. The image capturing apparatus 100 shoots an object and records the data of moving images, still images, or the like to various types of media, such as tape, a solid-state memory, an optical disk, a magnetic disk, or the like. The image capturing apparatus 100 is, for example, a digital still camera, a video camera, or the like, but is not limited thereto. The various units in the image capturing apparatus 100 are connected over a bus 160. Each unit is controlled by a central processing unit (CPU) 151. The image capturing apparatus 100 incorporates an image processing apparatus constituted by an image processing unit 152, an image compression/decompression unit 153, an object detection unit 162, an object categorization unit 163, a dictionary switching unit 164, and the like.

A lens unit 101 is configured including a fixed one-group lens 102, a zoom lens 111, an aperture stop 103, a fixed three-group lens 121, and a focus lens 131. An aperture control unit 105 adjusts the diameter of an opening in the aperture stop 103, to adjust an amount of light during shooting, by driving the aperture stop 103 via an aperture motor 104 (AM) in accordance with commands from the CPU 151. The aperture control unit 105 controls the exposure using a luminance value of a specific object region. A zoom control unit 113 changes a focal length by driving the zoom lens 111 using a zoom motor 112 (ZM). A focus control unit 133 determines a driving amount at which to drive a focus motor 132 (FM) on the basis of a shift amount in a focus direction of the lens unit 101. The focus control unit 133 controls a focus adjustment state by driving the focus lens 131 using the focus motor 132 (FM). AF control for a specific object region, for example, is implemented by the focus control unit 133 and the focus motor 132 controlling the movement of the focus lens 131. The focus lens 131 is a lens for adjusting the focus. While the focus lens 131 is illustrated as a single lens in FIG. 1A for simplicity, the focus lens 131 is normally constituted by a plurality of lenses.

An image sensor 141 is a photoelectric conversion element that photoelectrically converts an optical image of an object into an electrical signal. Light-receiving elements constituted by m pixels in the horizontal direction and n pixels in the vertical direction are arranged in the image sensor 141. An object image formed on an image sensor 141 via the lens unit 101 is converted into an electrical signal by the image sensor 141. The image formed on the image sensor 141 and photoelectrically converted is processed into an image signal (image data) by a captured image signal processing unit 142, and is obtained as an image of an image capturing plane. The image data output from the captured image signal processing unit 142 is sent to an image capturing control unit 143, and is temporarily held in a random access memory (RAM) 154. The image data held in the RAM 154 is compressed by the image compression/decompression unit 153 and then recorded into a recording medium 157. At the same time, the image data held in the RAM 154 is sent to the image processing unit 152.

The image capturing control unit 143 receives, from the CPU 151, an instruction for an accumulation time of the image sensor 141 and a setting value for gain used in output from the image sensor 141 to the captured image signal processing unit 142, and controls the image sensor 141. The CPU 151 sets the accumulation time and gain setting value on the basis of instructions from an operator input through an operation switch 156, or on the basis of the magnitude of a pixel signal in the image data temporarily held in the RAM 154.

The image processing unit 152 processes image signals, performs processing for enlarging or reducing the image data to an optimal size, calculates the similarity of image data, and the like. The image data that has been processed to the optimal size is sent to a display 150 and displayed as appropriate in order to display a preview image, a through-the-lens image, or the like. The object detection result from the object detection unit 162 can also be displayed in a superimposed manner in an image display on a display 150. For example, the object detection result can be displayed in a rectangle or the like on the display 150. Additionally, using the RAM 154 as a ring buffer makes it possible to buffer a plurality of items of image data captured within a predetermined period and detection results from the object detection unit 162 corresponding to each item of image data. Similarly, image data used for learning by the object detection unit 162, and object detection results corresponding to the image data, can be buffered. The image processing unit 152 also performs gamma correction, white balance processing, and the like based on the object region.

The operation switch 156 is an input interface including a touch panel, buttons, and the like. Various operations can be performed by using the operation switch 156 to select various function icons displayed on the display 150. For example, the user can select images to be used for machine learning, perform operations necessary for machine learning (for example, designating a two-dimensional correct answer region corresponding to the image), and the like while viewing a shot image displayed in the display 150. The user can also select an ML dictionary to be downloaded, instruct the download, and the like while viewing a GUI of the cloud system obtained through a communication unit 161 and displayed on the display 150.

The recording medium 157 is a recording medium such as an SD card, and image data output from the captured image signal processing unit 142, a plurality of ML dictionaries applicable in the object detection unit 162 and the object categorization unit 163, and the like are recorded therein. Training images used in respective instances of machine learning, association information (described later), and the like are also recorded in the ML dictionaries applied in the object detection unit 162. Icon images corresponding to each category and each class in the object categorization results are also recorded in the ML dictionary applied in the object categorization unit 163. The communication unit 161 communicates ML dictionaries, information related to ML dictionaries such as training images, and the like by connecting to a cloud system or the like over Ethernet or wirelessly.

The object detection unit 162 determines a region in which an object, such as a horse, is present using an image signal, by applying an ML dictionary selected from a plurality of ML dictionaries recorded in the recording medium 157. The object detection processing by the object detection unit 162 is implemented by feature extraction processing using a Deep Neural Network (DNN). The configuration of the object detection unit 162 will be described in detail later.

The object categorization unit 163 categorizes to which of predetermined classes an object belongs using an image signal, by applying an ML dictionary recorded in the recording medium 157. The categorization processing by the object categorization unit 163 is implemented by feature extraction processing using a Deep Neural Network (DNN). In the object categorization unit 163, appropriately switching the ML dictionary to be applied makes it possible to make various multi-class categories, such as a species category of the object, a posture category, a category for the presence or absence of ornaments, a hair color category, and the like. The configuration of the object categorization unit 163 will be described in detail later.

The dictionary switching unit 164 switches the ML dictionary used by the object detection unit 162 to an ML dictionary selected from the plurality of ML dictionaries in response to a predetermined user operation made on the operation switch 156. FIG. 1B is a block diagram illustrating an example of the functional configuration of the dictionary switching unit 164. A switching control unit 201 accepts user operations from the operation switch 156, controls the various functional units of the dictionary switching unit 164, and controls displays in the display 150 during the dictionary switching operation. A characteristic obtainment unit 202 provides a characteristic representation of the ML dictionary to the switching control unit 201 on the basis of the association information recorded in the recording medium 157. An association information generation unit 203 selects a training image to be used in the characteristic representation from a plurality of training images used in the machine learning of the ML dictionary, generates association information associating the ML dictionary with the selected training image, and records the association information in a recording medium 157. The dictionary switching unit 164 will be described in detail later.

Returning to FIG. 1A, a battery 159 is managed by a power source managing unit 158, and provides a stable supply of power to the image capturing apparatus 100 as a whole. Control programs necessary for the image capturing apparatus 100 to operate, parameters used in the operations of the various units, and the like are recorded in a flash memory 155. When the image capturing apparatus 100 is started up in response to a user operation (i.e., when the apparatus transitions from a power off state to a power on state), the control programs, parameters, and the like stored in the flash memory 155 are partially loaded into the RAM 154. The CPU 151 controls the operations of the image capturing apparatus 100 in accordance with control programs, parameters, and the like loaded into the RAM 154.

### (Configuration of Object Detection Unit 162)

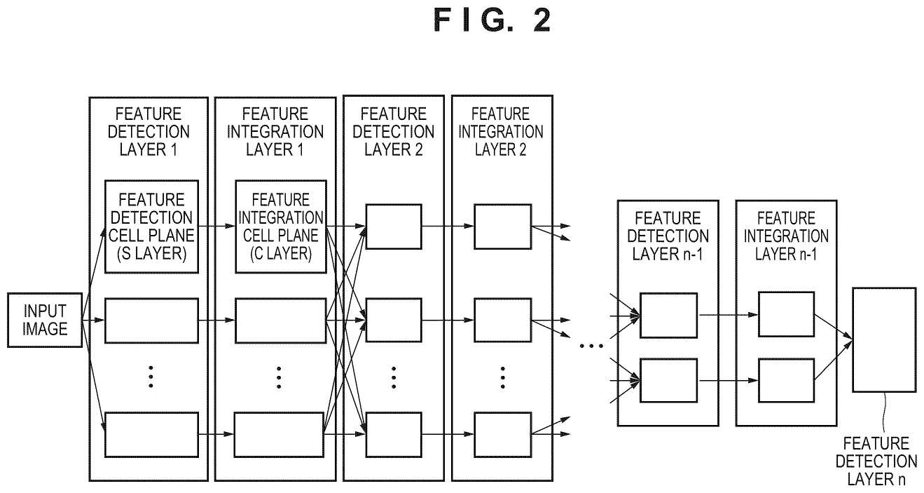

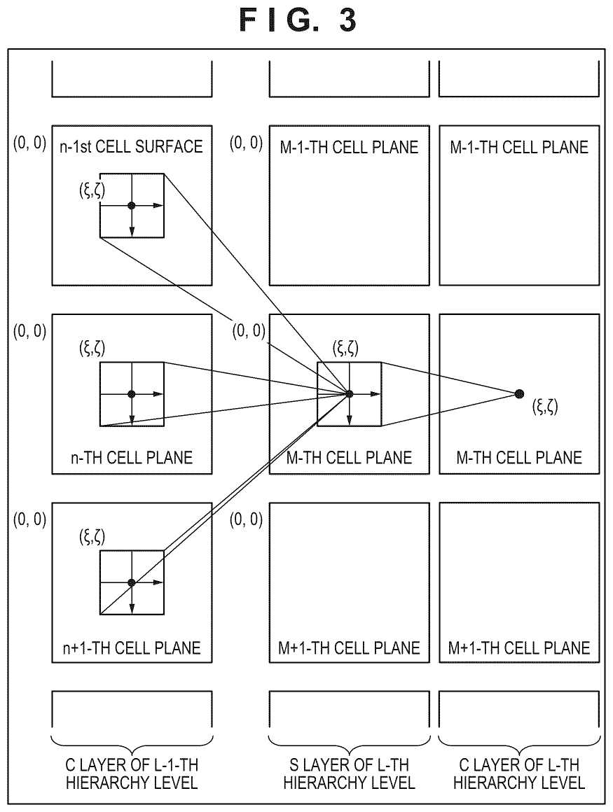

In the present embodiment, the object detection unit 162 is constituted by a Convolutional Neural Network (CNN), but is not limited thereto, and any DNN using machine learning technology serves as an embodiment of the present disclosure. The basic configuration of a CNN will be described with reference to FIGS. 2 and 3. FIG. 2 illustrates the basic configuration of a CNN that detects an object from two-dimensional image data that has been input. In FIG. 2, the left end corresponds to the input, and the processing advances with progress to the right. The CNN takes two layers, called a feature detection layer (an S layer) and a feature integration layer (a C layer) as a single set, and those sets are configured hierarchically.

With the CNN, first, in the S layer, the next feature is detected on the basis of a feature detected in the previous hierarchy level. The features detected in the S layer are integrated in the C layer, and the detection result in that hierarchy level is then sent to the next hierarchy level. The S layer is constituted by feature detection cell planes, and detects different features in each feature detection cell plane. The C layer is constituted by feature integration cell planes, and pools the detection results from the feature detection cell planes in the previous stage. Unless specified otherwise, the feature detection cell planes and the feature integration cell planes will be collectively referred to as “feature planes” in the following. In the present embodiment, an output layer, which is the final hierarchy level, is constituted only by S layers, and does not use C layers.

Feature detection processing in the feature detection cell plane and feature integration processing in the feature integration cell plane will be described in detail with reference to FIG. 3. The feature detection cell plane is constituted by a plurality of feature detection neurons, and the feature detection neurons are integrated in the C layers of the previous hierarchy level according to a predetermined structure. Meanwhile, the feature integration cell plane is constituted by a plurality of feature integration neurons, and the feature integration neurons are integrated in the S layers of the same hierarchy level according to a predetermined structure. In FIG. 3, in an M-th cell plane of the S layer in an L-th hierarchy level, the output value of the feature detection neuron at a position (ξ, ζ) is denoted as y^{LS}_{M}(ξ, ζ), and in an M-th cell plane of the C layer in an L-th hierarchy level, the output value of the feature integration neuron at position (ξ, ζ) is denoted as y^{LC}_{M}(ξ, ζ). Then, assuming that the coupling coefficients of the respective neurons are represented by w^{LS}_{M}(n, u, v) and w^{LC}_{M}(u, v), each output value can be expressed as the following [Math. 1] and [Math. 2].

$${y}_{M}^{LS} ( ξ , ζ ) ≡ f ( {u}_{M}^{LS} ( ξ , ζ ) ) ≡ f \{ {\sum }_{n , u , v} {w}_{M}^{LS} ( n , u , v ) \cdot {y}_{n}^{L - 1 C} ( ξ + u , ζ + v ) \} \qquad [ Math . 1 ]$$

$${y}_{M}^{LC} ( ξ , ζ ) ≡ {u}_{M}^{LC} ( ξ , ζ ) ≡ {\sum }_{u , v} {w}_{M}^{LC} ( u , v ) \cdot {y}_{M}^{LS} ( ξ + u , ζ + v ) \qquad [ Math . 2 ]$$

f in [Math. 1] is an activation function, such as any sigmoid function such as a logistic function or a hyperbolic tangent function, and may be realized by a tan h function, for example. u^{LS}_{M}(ξ, ζ) represents the internal state of the feature detection neuron at position (ξ, ζ) in the M-th cell plane of the S layer in the L-th hierarchy level. [Math. 2] finds a simple linear sum without using an activation function. When an activation function is not used, as in [Math. 2], the internal state u^{LC}_{M}(ξ, ζ) and the output value y^{LC}_{M}(ξ, ζ) of the neuron are equal. y^{L-1C}ₙ(ξ+u, ζ+v) in [Math. 1] and y^{LS}_{M}(ξ+u, ζ+v) in [Math. 2] are called “integration destination output values” of the feature detection neuron and the feature integration neuron, respectively.

ξ, ζ, u, v, and n in [Math. 1] and [Math. 2] will be described next. The position (ξ, ζ) corresponds to positional coordinates in the input image, and for example, when y^{LS}_{M}(ξ, ζ) is a high output value, it is highly likely that a feature to be detected in the M-th cell plane of the S layer in the L-th hierarchy level is present at a pixel position (ξ, ζ) in the input image. n in [Math. 2] indicates an n-th cell plane in the C layer of an L−1-th hierarchy level, and is called an “integration destination feature number”. Basically, a product-sum operation is performed for all cell planes present in the C layer of the L−1-th hierarchy level. (u,v) represents relative positional coordinates of the coupling coefficient, and a product-sum operation is performed in a limited range (u, v) in accordance with the size of the feature to be detected. This limited range of (u, v) is called a “receptive field”. The size of the receptive field will be called the “receptive field size” hereinafter, and is expressed as a number of horizontal pixels×a number of vertical pixels in an integrated range.

In [Math. 1], in the S layer where L=1, i.e., the first S layer, y^{L-1C}ₙ(ξ+u ζ+v) is an input image y^{in-image}(ξ+u, ζ+v) or an input position map y^{in-posi-map}(ξ+u, ζ+v). Incidentally, neurons, pixels, and the like are distributed discretely, and the integration destination feature number is also discrete. ξ, ζ, u, v, and n are thus discrete values rather than continuous variables. Here, ξ and ζ are non-negative integers, n is a natural number, and u and v are integers, and all have limited ranges.

w^{LS}_{M}(n, u, v) in [Math. 1] represents a coupling coefficient distribution for detecting a predetermined feature, and the predetermined feature can be detected by adjusting that coupling coefficient distribution to an appropriate value. The adjustment of the coupling coefficient distribution is training, and in the CNN architecture, the coupling coefficient is adjusted by presenting a variety of test patterns to repeatedly and gradually correct the coupling coefficient such that y^{LS}_{M}(ξ, ζ) becomes an appropriate output value.

Next, w^{LC}_{M}(u, v) in [Math. 2] uses a two-dimensional Gaussian function, and can be expressed as indicated by the following [Math. 3].

$${w}_{M}^{LC} ( u , v ) = \frac{1}{2 π {σ}_{L , M}^{2}} \cdot exp ( - \frac{{u}^{2} + {v}^{2}}{2 {σ}_{L , M}^{2}} ) \qquad [ Math . 3 ]$$

Here, (u, v) is a limited range, and as with the feature detection neuron, the limited range will be called a “receptive field” and the size of the range will be called a “receptive field size”. The receptive field size may be set to any suitable value in accordance with the size of the M-th feature in the S layer of the L-th hierarchy level. In [Math. 3], σ represents a feature size factor, and may be set to any suitable constant in accordance with the receptive field size. Specifically, σ may be set such that values furthest on the outside of the receptive field are values that can substantially be treated as zero.

The object detection unit 162 performing object detection in the S layer of the final hierarchy level by performing computations such as those described above in each hierarchy level is the configuration of the object detection unit 162 according to the present embodiment.

### (Learning Method of Object Detection Unit 162)

A specific learning method for the object detection unit 162 will be described next. In the present embodiment, the coupling coefficient is adjusted through supervised learning. In supervised learning, an actual neuron output value is found by supplying a test pattern, and based on a relationship between the output value and a target signal (a desired output value to be output by that neuron), the coupling coefficient w^{LS}_{M}(n, u, v) may be adjusted. In the learning according to the present embodiment, the coupling coefficient is corrected by using the least-squares method in the final feature detection layer and using an error back propagation method in intermediate feature detection layers. Details of the method for correcting the coupling coefficient, such as the least-squares method and the error back propagation method, can be found in NPL 1.

In the object detection unit 162, many specific patterns to be detected and patterns not to be detected are prepared as test patterns for the learning. Each test pattern takes an image and a target signal as a single set. If the tan h function is used for the activation function, when the specific pattern to be detected is presented, the target signal is supplied so that an output of 1 is obtained for the neurons, in the feature detection cell plane in the final layer, located in the regions where the specific pattern is present. Conversely, when a pattern not to be detected is presented, the target signal is supplied so that an output of −1 is obtained for the neurons located in the regions of that pattern. In actual detection, computations are performed using the coupling coefficient w^{LS}_{M}(n, u, v) constructed through learning, and if the neuron output in the feature detection cell plane of the final layer is at least a predetermined value, the object is determined to be present. In this manner, the object detection unit 162 is constructed such that an object can be detected from a two-dimensional image.

### (Configuration of Object Categorization Unit 163)

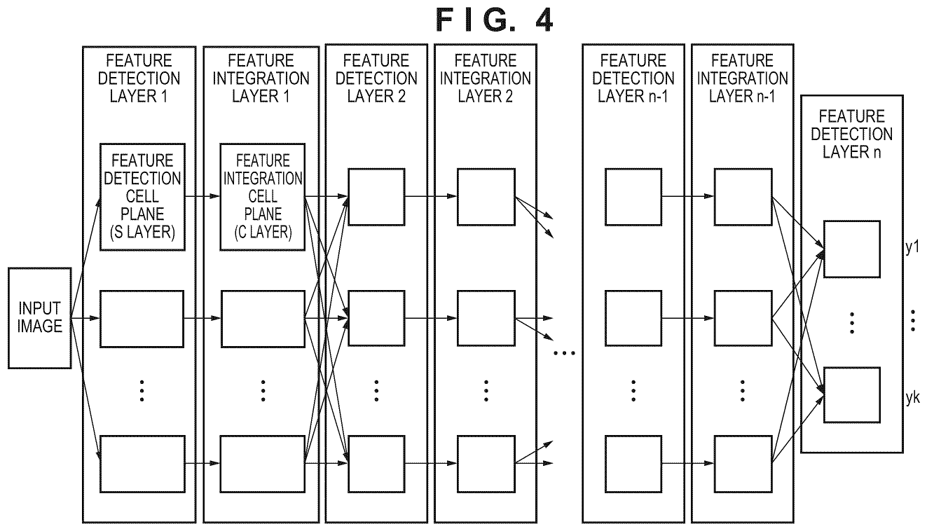

In the present embodiment, the object categorization unit 163 is constituted by a CNN, but is not limited thereto, and any DNN using machine learning technology serves as an embodiment of the present disclosure. The basic configuration of the CNN will be described with reference to FIG. 4. The CNN of the object categorization unit 163 is configured such that the number of outputs k of the n layers corresponds to the number of classes to be categorized. A softmax function is used for the activation function. Other parts are the same as in the configuration of the object detection unit 162 and will therefore not be described. Performing computations such as those described above in each hierarchy level, and performing object categorization in the S layer of the final hierarchy level of the object categorization unit 163, is the CNN configuration of the object categorization unit 163 according to the present embodiment.

### (Learning Method of Object Categorization Unit 163)

A specific learning method for the object categorization unit 163 will be described next. In the object categorization unit 163, many specific patterns to be categorized are prepared for each of many classes. Each test pattern takes an image and a target signal as a single set. When a softmax function is used for the activation function, the target signal is supplied such that the output of a correct answer class is 1, and outputs other than the correct answer class is 0. In actual categorization, computations are performed using the coupling coefficient w^{LS}_{M}(n,u,v) constructed through learning, and the object is determined to belong to a class for which the neuron output in the feature detection cell plane of the final layer is at least a predetermined value.

A plurality of ML dictionaries, for which learning such as that described above has been performed for each of the plurality of multi-class categories, are prepared in advance and recorded in the recording medium 157. Other parts are the same as in the method for the object detection unit 162 and will therefore not be described. In this manner, the object categorization unit 163 is constructed such that an object can be categorized into multiple classes from a two-dimensional image.

### (Flow of Overall Processing by Dictionary Switching Unit 164)

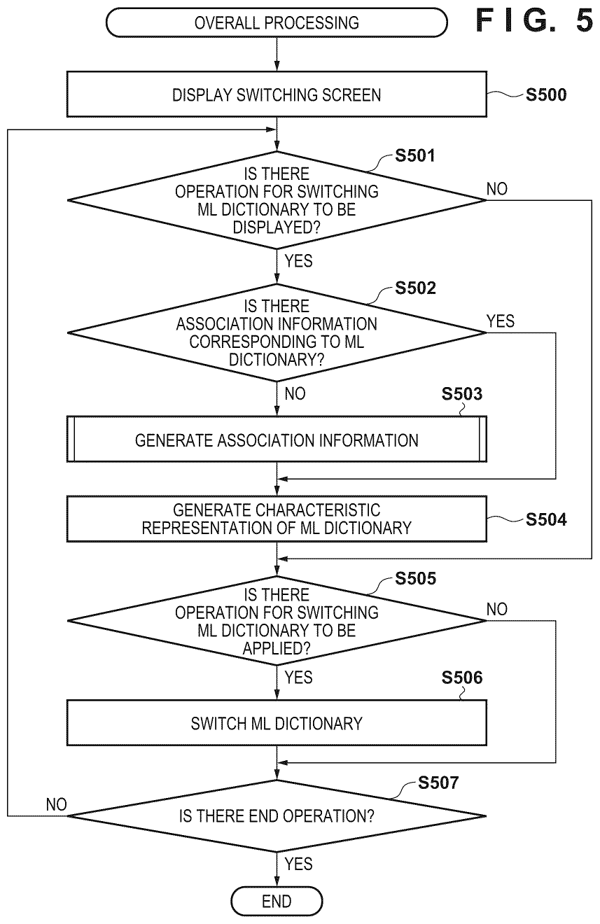

FIG. 5 is a flowchart illustrating the overall processing performed by the dictionary switching unit 164 according to the present embodiment. Note that each functional unit of the dictionary switching unit 164 illustrated in FIG. 1B may be realized by the CPU 151 executing predetermined software, by dedicated hardware, or by software and hardware operating cooperatively.

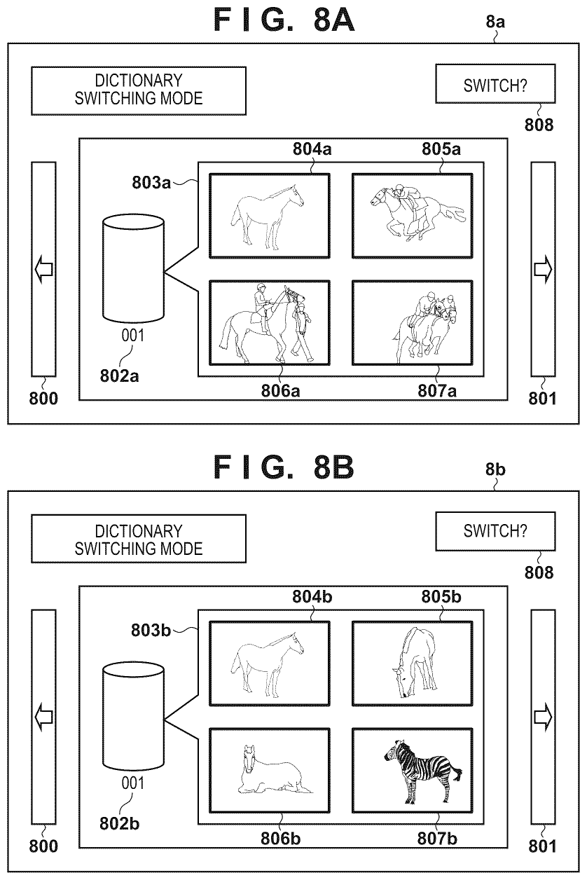

In S500, the switching control unit 201 displays an ML dictionary switching screen on the display 150 in response to a predetermined user operation made using the operation switch 156 (an ML dictionary switching operation). A specific example of the switching screen will be described later with reference to FIGS. 8A and 8B. In S501, the switching control unit 201 determines whether an operation for switching the ML dictionary displayed on the switching screen has been made by the user through the operation switch 156. If the switching control unit 201 determines that an operation for switching the ML dictionary has been made (YES in S501), the sequence moves to S502, whereas if the switching control unit 201 determines that such an operation has not been made (NO in S501), the sequence moves to S505.

In S502, the characteristic obtainment unit 202 determines whether association information for the new ML dictionary to be displayed, which was switched to in S501, is recorded in the recording medium 157. If the characteristic obtainment unit 202 determines that association information for the ML dictionary to be displayed is not recorded in the recording medium 157 (NO in S502), the sequence moves to S503. However, if the characteristic obtainment unit 202 determines that association information for the ML dictionary to be displayed is recorded in the recording medium 157 (YES in S502), the sequence moves to S504.

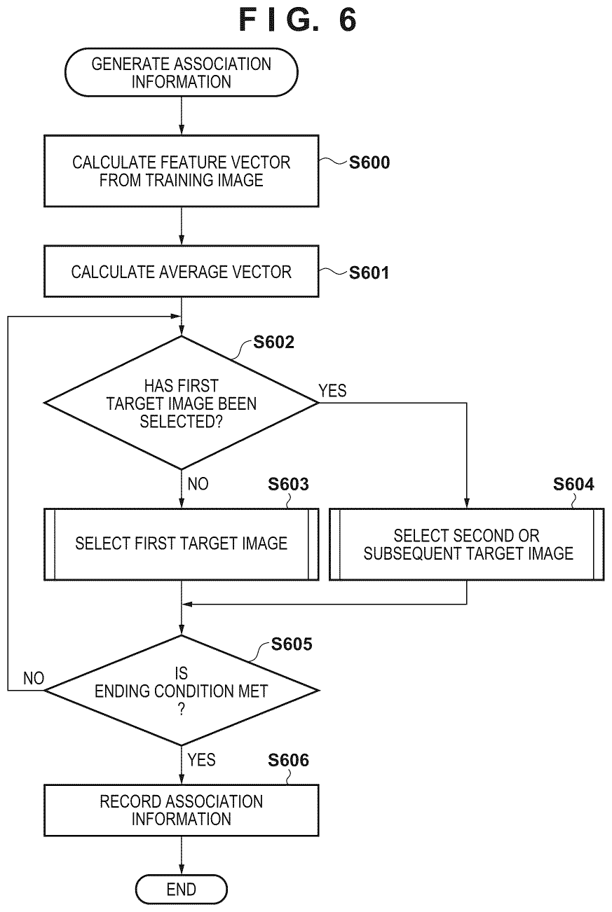

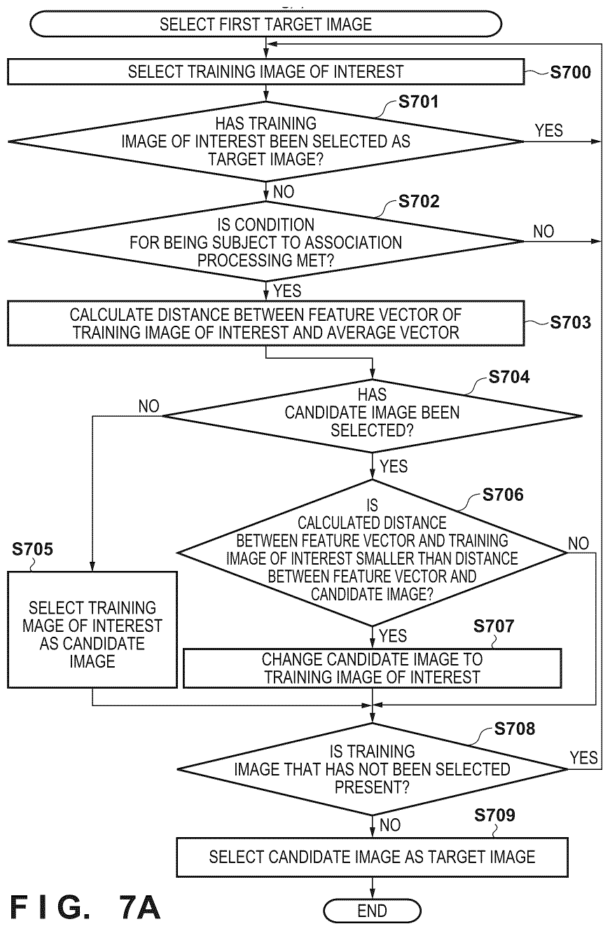

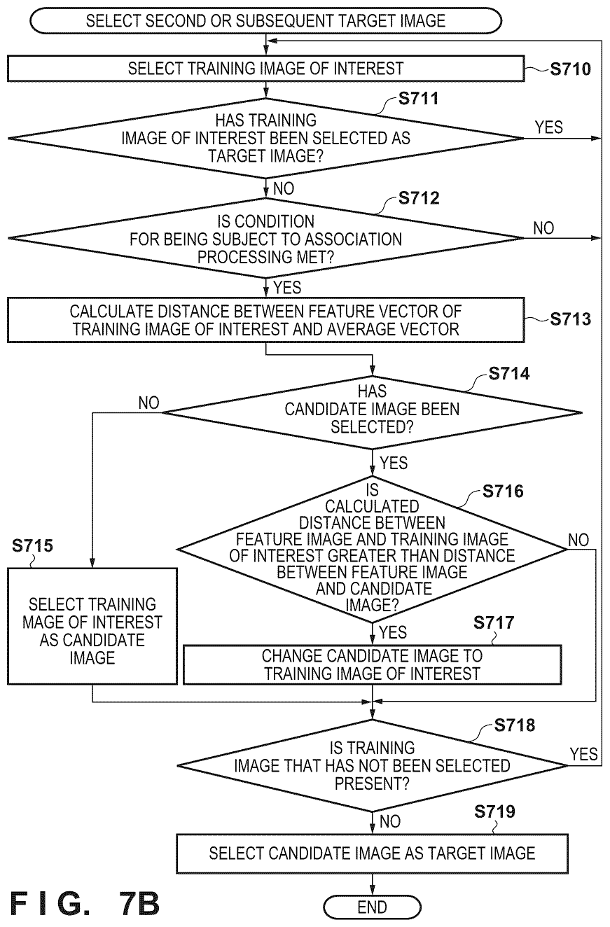

In S503, the association information generation unit (“generation unit” hereinafter) 203 reads out the ML dictionary to be displayed after the display switching operation in S501, and a plurality of training images to be used to train the ML dictionary to be displayed, from the recording medium 157, and generates the association information for the ML dictionary. The generation unit 203 records the obtained association information into the recording medium 157. Here, the “association information” is information expressing a pair including an ML dictionary and a target image selected to express the characteristics of the ML dictionary, and includes the target image itself. The processing for generating the association information performed in S503 will be described in detail later with reference to FIGS. 6, 7A, and 7B.

Next, in S504, the characteristic obtainment unit 202 reads out the association information pertaining to the ML dictionary to be displayed after the switching operation has been performed in S501 from the recording medium 157, and obtains a training image associated by the read-out association information. The switching control unit 201 expresses the characteristics of the ML dictionary to be displayed after the switching by displaying the ML dictionary to be displayed, and a plurality of training images obtained by the characteristic obtainment unit 202, on the display 150. The display on the display 150 and the method for expressing the characteristics of the ML dictionary will be described in detail later with reference to FIGS. 8A and 8B.

In S505, the switching control unit 201 determines whether an operation for switching the ML dictionary to be applied in the object detection unit 162 has been made by the user through the operation switch 156 for the ML dictionary currently displayed on the switching screen. If the switching control unit 201 determines that an operation for switching the ML dictionary has been made (YES in S505), the sequence moves to S506. However, if the switching control unit 201 determines that an operation for switching the ML dictionary has not been made (NO in S505), the sequence moves to S507. In S506, the switching control unit 201 switches the ML dictionary applied in the object detection unit 162 to the ML dictionary to be displayed on the current switching screen in accordance with the switching operation made by the user. Thereafter, object detection processing using the ML dictionary switched to in S506 can be performed on through-the-lens images, captured images, and the like in the image capturing apparatus 100. In S507, the switching control unit 201 determines whether an end operation has been made by the user through the operation switch 156. If the switching control unit 201 determines that an end operation has been made (YES in S507), the sequence ends. However, if the switching control unit 201 determines that an end operation has not been made (NO in S507), the sequence returns to S501, and the foregoing processing is repeated.

### (Flow of Association Information Generation Processing)

FIG. 6 is a flowchart illustrating processing for generating the association information, executed in S503 of the first embodiment.

In S600, the generation unit 203 calculates a feature vector for each of the plurality of training images (“corresponding image group” hereinafter) used in the machine learning for the ML dictionary to be displayed after the switching in S500. These corresponding image groups are recorded in the recording medium 157 in correspondence with the ML dictionary. Although it is desirable that the corresponding image group include all the training images used in the machine learning for the ML dictionary, the corresponding image group may be constituted by training images randomly extracted from all the training images used in the machine learning, to the extent that the effects of the present disclosure are not affected. Note that a publicly-known method for calculating a feature vector from an image can be used to calculate the feature vector in S600. Alternatively, each training image may be input to the object detection unit 162, and the output of a feature integration layer n-1, which is intermediate data obtained by the object detection unit 162, may be used as the feature vector. Alternatively, each training image may be input to the object categorization unit 163 in which any one of the ML dictionaries recorded in the recording medium 157 is applied, and the output of the feature integration layer n-1, which is intermediate data obtained by the object categorization unit 163, may be used as the feature vector.

In S601, the generation unit 203 calculates an average vector using the feature vectors calculated in S600. In S602, the generation unit 203 determines whether a first target image has been selected. If the generation unit 203 determines that the first target image has not been selected (NO in S602), the sequence moves to S603, whereas if the generation unit 203 determines that the first target image has been selected (YES in S602), the sequence moves to S604.

In S603, the generation unit 203 selects a first target image from the corresponding image group. The processing for selecting the first target image will be described in detail later with reference to the flowchart in FIG. 7A. In S604, the generation unit 203 selects a second or subsequent target image from the corresponding image group. The processing for selecting the second target image will be described in detail later with reference to the flowchart in FIG. 7B. Next, in S605, the generation unit 203 determines whether an ending condition is met. If the generation unit 203 determines that the ending condition is met (YES in S605), the sequence moves to S606. However, if the generation unit 203 determines that the ending condition is not met (NO in S605), the sequence returns to S602, and the foregoing processing is repeated. Here, in the present embodiment, a target image selection number is used as the ending condition in S605. The target image selection number is set in consideration of a size that can be viewed by the user when the training images are displayed on the display 150 in the display expressing the characteristics of the ML dictionary (S504). In the present embodiment, this number is set to four images (the first target image, and three images among the second and subsequent target images), for example. In S606, the generation unit 203 records information specifying the training images selected in S603 and S604 into the recording medium 157 as the association information pertaining to the ML dictionary to be displayed.

### (Target Image Selection Processing)

FIG. 7A is a flowchart illustrating processing for selecting the first target image (S603). The generation unit 203 selects, as the first target image, the training image having the feature vector which, of the plurality of feature vectors obtained from the corresponding image group (the plurality of training images), has the smallest distance from the average vector of the plurality of feature vectors.

In S700, the generation unit 203 selects a training image of interest from the corresponding image group. In S701, the generation unit 203 determines whether the training image of interest selected in S700 has been selected as the target image. If the generation unit 203 determines that the training image of interest has been selected as the target image (YES in S701), the sequence returns to S700, and the next training image of interest is selected. However, if the generation unit 203 determines that the training image of interest has not been selected as the target image (NO in S701), the sequence moves to S702. Because the selection of the target image is performed repeatedly in the flowchart illustrated in FIG. 6, the determination in this step is made with the intention of ensuring the target image is not selected twice. Note that S701 can be omitted when the target image selected using the processing of S603 is a single image as indicated in FIG. 6. However, S701 is required when the processing for selecting the plurality of target images is performed in order from the shortest distance with respect to the average vector (e.g., when a plurality of target images are selected through the processing of S603).

In S702, the generation unit 203 determines whether the training image of interest selected in S700 meets a condition for being subject to association processing. If the generation unit 203 determines that the training image of interest meets the condition for being subject to the association processing (YES in S702), the sequence moves to S703. However, if the generation unit 203 determines that the training image of interest does not meet the condition for being subject to the association processing (NO in S702), the sequence returns to S700. In machine learning, even if an image is included in the training images, the image may not have a sufficient impact on the performance of the ML dictionary. As such, as one of the conditions for being subject to the association processing (conditions for being selected as a target image), a condition is set to ensure that training images which have little impact on the characteristics of the ML dictionary are not selected as target images. More specifically, the condition for being subject to the association processing is that an object can be detected when the training image of interest is input to the object detection unit 162. Note that at this time, the ML dictionary to be displayed is temporarily set in the object detection unit 162. Alternatively, the condition may be that of the feature vectors calculated in S600, the percentage of the feature vectors for which the distance from the feature vector calculated from the training image of interest is sufficiently small (feature vectors for which the distance is no greater than a predetermined threshold) is at least a predetermined percentage. Furthermore, here, the “distance” may be any numerical value representing the similarity of feature vectors, e.g., a Euclidean distance or a cosine similarity between the vectors.

In S703, the generation unit 203 calculates a distance between the feature vector, among the feature vectors calculated in S600, that has been calculated from the training image of interest, and the average vector calculated in S601. The distance between the vectors is the same as the distance described with reference to S702. In S704, the generation unit 203 determines whether a candidate image has been selected in S705, which will be described later. If the generation unit 203 determines that a candidate image has not been selected (NO in S704), the sequence moves to S705, whereas if the generation unit 203 determines that a candidate image has been selected (YES in S704), the sequence moves to S706.

In S705, the generation unit 203 selects the training image of interest as a candidate image. Meanwhile, in S706, the generation unit 203 determines whether the distance between the feature vector of the training image of interest and the average vector is smaller than the distance between the feature vector of the candidate image selected in S705 or S707 and the average vector. If the generation unit 203 determines that the distance between the feature vector of the training image of interest and the average vector is smaller than the distance between the feature vector of the candidate image and the average vector (YES in S706), the sequence moves to S707. However, if the generation unit 203 determines that the distance between the feature vector of the training image of interest and the average vector is not smaller than the distance between the feature vector of the candidate image and the average vector (NO in S706), the sequence moves to S708. The determination in S706 is made with the intention of selecting, as the candidate image, a training image from which a feature vector having a smaller distance from the average vector can be obtained. In S707, the generation unit 203 changes the candidate image to a current training image of interest.

In S708, the generation unit 203 determines whether a training image that has not been selected as the training image of interest is present in the corresponding image group. If the generation unit 203 determines that a training image that has not been selected as the training image of interest is present (YES in S708), the sequence returns to S700, and the foregoing processing is repeated. However, if the generation unit 203 determines that a training image that has not been selected as the training image of interest is not present (NO in S708), the sequence moves to S709. In S709, the generation unit 203 selects a training image of interest that is a candidate image as the target image.

According to the processing of FIG. 7A as described above, a training image from which the feature vector having the smallest distance from the average vector is obtained is selected as the target image from the corresponding image group. In other words, a representative training image representing the performance of the ML dictionary instructed to be switched to in S501 is selected.

FIG. 7B is a flowchart illustrating processing for selecting the second and subsequent target images, executed in S604 of the first embodiment. In this processing, the generation unit 203 selects a predetermined number of feature vectors from the plurality of feature vectors obtained from the corresponding image group, in order from the feature vector having the greatest distance from the average vector of the plurality of feature vectors. Therefore, by repeating S604 a predetermined number of times, a predetermined number of training images are selected in order from the image for which the distance between the feature vector and the average vector is greatest. In FIG. 7B, the processes of S710 to S719, excluding S716, are the same as the processes of S700 to S709, excluding S706, in FIG. 7A. In S716, the generation unit 203 determines whether the distance between the feature vector of the training image of interest and the average vector is greater than the distance between the feature vector of the candidate image selected in S715 or S717 and the average vector. If the generation unit 203 determines that the distance between the feature vector of the training image of interest and the average vector is greater than the distance between the feature vector of the candidate image and the average vector (YES in S716), the sequence moves to S717. However, if the generation unit 203 determines that the distance between the feature vector of the training image of interest and the average vector is not greater than the distance between the feature vector of the candidate image and the average vector (NO in S716), the sequence moves to S718. The determination in S716 is made with the intention of selecting, as the candidate image, a training image from which a feature vector having a greater distance from the average vector can be calculated.

According to the processing of FIG. 7B as described above, a training image from which the feature vector having the greatest distance from the average vector is obtained is selected as the target image from the corresponding image group. In other words, a special training image representing the performance of the ML dictionary instructed to be switched to in S501 is selected.

### (Example of Display of Dictionary Characteristics)

FIGS. 8A and 8B are diagrams illustrating examples of the switching screen displayed on the display 150 by the switching control unit 201 through the processes of S500 and S504. When a dictionary switching mode is designated, the switching control unit 201 displays a switching screen 8a illustrated in FIG. 8A, for example. Items 800 and 801 are GUIs for switching the ML dictionary to be displayed by operating the operation switch 156. When the item 800 or 801 is manipulated, in S501, the switching control unit 201 determines that an operation for switching the ML dictionary to be displayed has been made. An item 802a is the ML dictionary to be displayed, and is indicated by “001”, which is the filename of that ML dictionary recorded in the recording medium 157.

An area 803a is an area for expressing the characteristics of the ML dictionary, and is displayed by the processing of S504. In the example in FIG. 8A, training images 804a to 807a, which are the target images selected to express the characteristics of the ML dictionary “001”, are displayed. The training image 804a is the training image selected as the first target image in S603. In S603, the representative training image is easily selected, and the training image 804a is an example of a training image in which one horse is standing on four legs. The training images 805a, 806a, and 807a are training images selected as the second and subsequent target images in S604. In S604, a special training image is easily selected, and the training images 805a to 807a are examples of training images in which a rider, ornaments, a plurality of objects, and the like are present. A switching button 808 is a GUI that accepts user operations for switching the ML dictionary applied in the object detection unit 162. When the switching button 808 is operated, switching the ML dictionary applied in S505 is determined to have been instructed.

As described above, the switching control unit 201 generates display information for displaying a dictionary and at least one training image in association with each other on the basis of the association information, and functions as a display information generation unit that displays those items on the display 150. The dictionary characteristics of each dictionary are then presented to the user according to this display information. From the display illustrated in FIG. 8A, for example, the user can understand in advance that the ML dictionary “001” is an ML dictionary suitable for shooting images at a racecourse or the like, for example.

FIG. 8B will be described next. The items 800 and 801 and the switching button 808 are the same as in FIG. 8A. An item 802b indicates the ML dictionary to be displayed in response to the item 800 or 801 being operated, and is indicated by “002”, which is the filename of that ML dictionary recorded in the recording medium 157. Training images 804b to 807b, which are the target images selected to express the characteristics of the ML dictionary “002”, are displayed in an area 803b. The training image 804b is an example of the training image selected as the first target image in S603. The training images 805b, 806b, and 807b are examples of training images selected as the second and subsequent target images in S604. In S604, a special training image is easily selected, and the training images 805b to 807b are examples of characteristic training images such as a horse with its head down, in a posture such as prone, a similar species such as a zebra, and the like.

By displaying dictionary characteristics as described with reference to FIG. 8B above, the user can understand in advance that the dictionary is an ML dictionary suitable for shooting images at a zoo or the like, for example.

As described above, according to the first embodiment, training images having representative features and special features with respect to an ML dictionary are displayed. Accordingly, by confirming those images, the user can select the ML dictionary to be applied having understood, in advance, the overall characteristics of the dictionary. Note that in the foregoing embodiment, the total number of selected target images is four, the number of target images selected through the processing of S603 (FIG. 7A) (representative training images) is one, and the number of target images selected through the processing of S604 (FIG. 7B) (special training images) is three. However, the present disclosure is not limited thereto, and the total number of target images, the number of representative training images, and the number of special training images may be set as desired. However, because using special training images makes it possible to express a broader range of the characteristics of the ML dictionary, it is desirable that the number of special training images be higher than the number of representative training images, from the standpoint of understanding the comprehensive characteristics.

### Second Embodiment

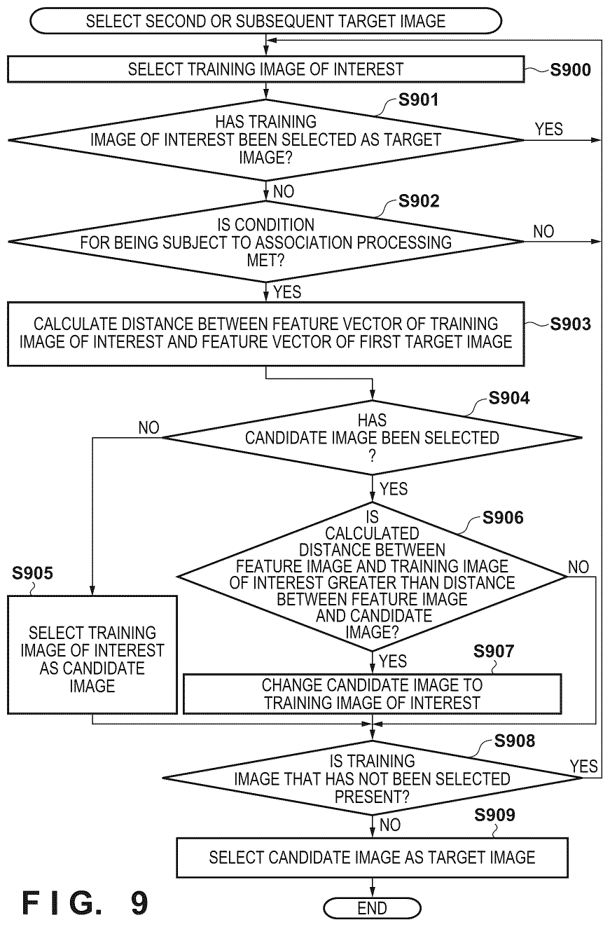

In the first embodiment, the distance between the feature vector of the training image of interest and the average vector was used to determine whether to select the training image of interest as the second or subsequent target image. In a second embodiment, the distance from the feature vector of the first target image (a representative training image) is used to determine whether to select the training image of interest as the second or subsequent target image. The configuration, functions, and processing of the image capturing apparatus 100 of the second embodiment are the same as in the first embodiment, with the exception of the processing for selecting the second and subsequent target images. The processing for selecting the second and subsequent target images according to the second embodiment (the processing in S604 of FIG. 6) will be described hereinafter with reference to FIG. 9.

### (Processing for Selecting Association Target Image)

FIG. 9 is a flowchart illustrating processing for selecting the second and subsequent target images, executed in S604 of the second embodiment. The processing of S900 to S909, excluding S903 and S906, is the same as the processing of S710 to S719, excluding S713 and S716, in the first embodiment (FIG. 7B).

In S903, the generation unit 203 calculates a distance between the feature vector calculated from the training image of interest and the feature vector calculated from the first target image selected in S603. Note that these feature vectors are calculated in S600. In S906, the generation unit 203 determines whether the distance between the feature vector of the training image of interest and the feature vector of the first target image is greater than the distance between the feature vector of the candidate image selected in S905 or S907 and the feature vector of the first target image. If the generation unit 203 determines that the distance between the feature vector of the training image of interest and the feature vector of the first target image is greater than the distance between the feature vector of the selected candidate image and the feature vector of the first target image (YES in S906), the sequence moves to S907. If the generation unit 203 determines that the distance between the feature vector of the training image of interest and the feature vector of the first target image is not greater than the distance between the feature vector of the selected candidate image and the feature vector of the first target image (NO in S906), the sequence moves to S908. The determination in S906 is made with the intention of selecting, as the candidate image, a training image from which a feature vector having a greater distance from the feature vector of the first selected image can be calculated.

As described above, according to the second embodiment, training images having representative features and special features are displayed, and by confirming those images, the user can select an ML dictionary to be applied having understood the overall dictionary characteristics in advance.

### Third Embodiment

In the first and second embodiments, the training image used to express the characteristics of the ML dictionary applied in the object detection unit 162 (i.e., the training image associated with the ML dictionary) was selected on the basis of the feature vector of the training image. In a third embodiment, the training image used to express the characteristics of the ML dictionary applied in the object detection unit 162 is selected on the basis of a result of the object categorization unit 163 categorizing the plurality of training images used in the machine learning for the ML dictionary into a plurality of classes. The overall processing by the dictionary switching unit 164 according to the third embodiment is the same as in the first embodiment and the second embodiment (FIG. 5), with the exception of the association information generation processing in S503 and the method for displaying the dictionary characteristics in S504.

### (Association Information Generation Processing (S503))

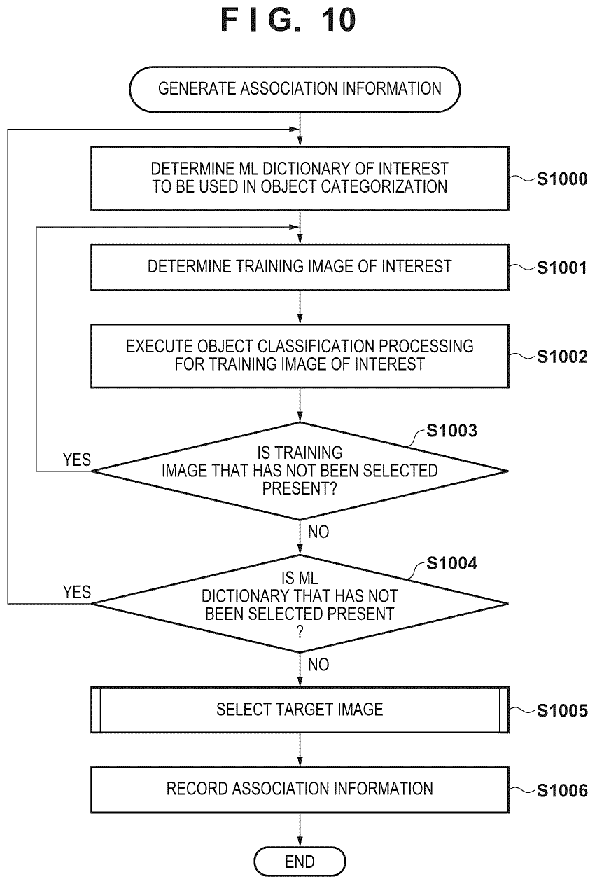

FIG. 10 is a flowchart illustrating association information generation processing according to the third embodiment. First, in S1000, the generation unit 203 selects an ML dictionary of interest from a plurality of ML dictionaries applied in the object categorization unit 163 and recorded in the recording medium 157 (“corresponding ML dictionary group” hereinafter), and applies the selected ML dictionary in the object categorization unit 163. Note that the corresponding ML dictionary group may be selected in accordance with the object to which the ML dictionary applied in the object detection unit 162 (the ML dictionary instructed to be switched to in S501) corresponds. For example, if the ML dictionary applied in the object detection unit 162 is a dictionary for detecting “horses”, the corresponding ML dictionary group may be constituted by ML dictionaries pertaining to the category of “horses.” Next, in S1001, the generation unit 203 selects a training image of interest from a plurality of training images recorded in the recording medium 157 (“corresponding image group” hereinafter), in correspondence with the ML dictionary instructed to be switched to in S501 (the ML dictionary applied in the object detection unit 162). Although it is desirable that the corresponding image group include all the training images used in the machine learning for the ML dictionary here, training images extracted randomly may be used, to the extent that the effects of the present disclosure are not affected. In S1002, the generation unit 203 causes the object categorization unit 163 to process the training image of interest and perform object categorization in which the ML dictionary of interest is applied. In S1003, the generation unit 203 determines whether a training image that has not been selected as the training image of interest in S1001 is present in the corresponding image group. If the generation unit 203 determines that a training image that has not been selected as the training image of interest is present in the corresponding image group (YES in S1003), the sequence returns to S1001, and the foregoing processing is repeated. However, if the generation unit 203 determines that a training image that has not been selected as the training image of interest is not present in the corresponding image group (NO in S1003), the sequence moves to S1004.

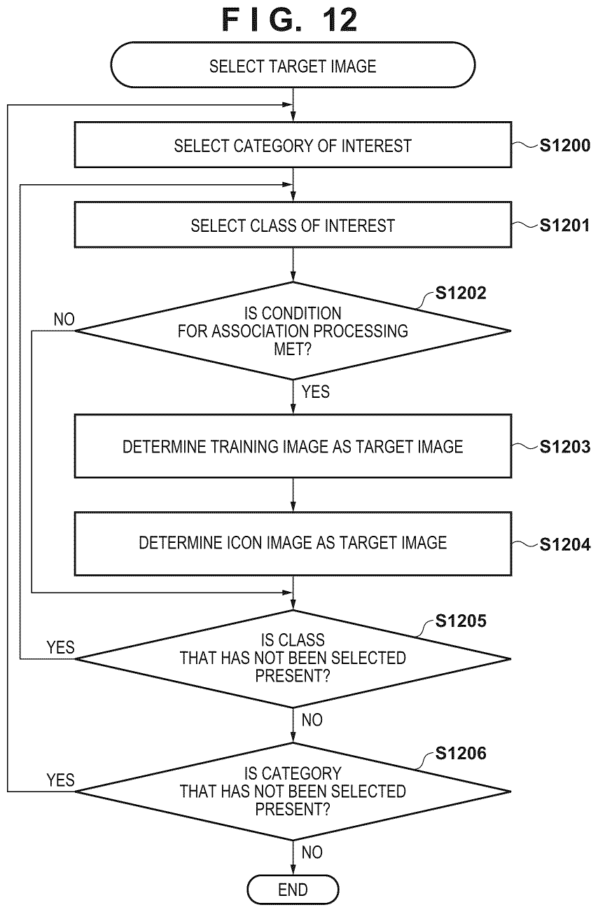

In S1004, the generation unit 203 determines whether an ML dictionary that has not been selected as the ML dictionary of interest in S1000 is present in the corresponding ML dictionary group. If the generation unit 203 determines that an ML dictionary that has not been selected as the ML dictionary of interest is present in the corresponding ML dictionary group (YES in S1004), the sequence returns to S1000, and the foregoing processing is repeated. However, if the generation unit 203 determines that an ML dictionary that has not been selected as the ML dictionary of interest is not present in the corresponding ML dictionary group (NO in S1004), the sequence moves to S1005. In S1005, the generation unit 203 selects a target image for expressing the characteristics of the ML dictionary from the training images and the icon images recorded in the recording medium 157, on the basis of the object categorization results obtained in S1000 to S1004. The selection of the target image will be described later with reference to the flowchart in FIG. 12. In S1006, the generation unit 203 records information specifying the target image selected in S1005 into the recording medium 157 as the association information of the ML dictionary to be displayed. Here, the “association information” is information on a combination of the target image selected in S1005 in correspondence with the ML dictionary to be displayed for which the switching operation was performed in S501, and the target image itself.

### (Example of Object Categorization Result)

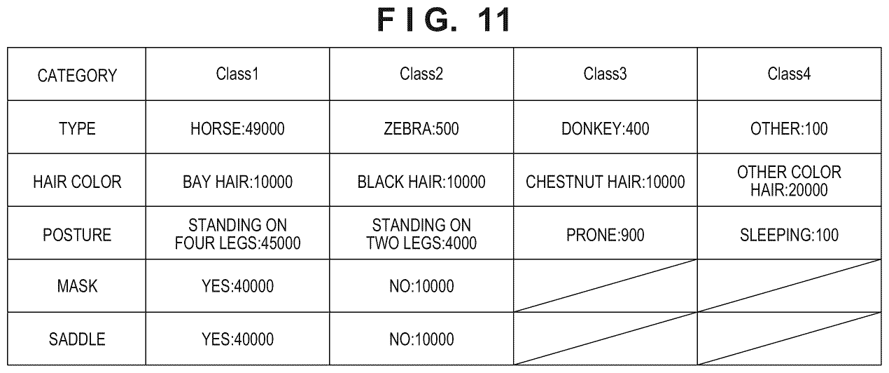

FIG. 11 illustrates an example of an object categorization result obtained through the processing of S1000 to S1004 of the present embodiment. In the example in FIG. 11, five object categories, pertaining to “species”, “hair color”, “posture”, “mask”, and “saddle”, are made, and the meaning and number of training images for each class into which the training image group has been categorized are described. Classes of “species” are, for example, “horse”, “zebra”, “donkey”, “other”, and the like. Classes of “hair color” are “bay hair”, “black hair”, “chestnut hair”, “other”, and the like. Classes of “posture” are “standing on four legs”, “standing on two legs”, “prone”, “sleeping”, and the like. Classes of “mask” and “saddle” are “yes” and “no”.

### (Target Image Selection Processing)

FIG. 12 is a flowchart illustrating processing for selecting the target image performed in the third embodiment.

In S1200, the generation unit 203 selects a category of interest from the object categorization results obtained in S1000 to S1004. Here, “category” is a category obtained by the ML dictionary of interest selected in S1000, and in the example in FIG. 11, is either “species”, “hair color”, “posture”, “mask”, or “saddle”. In S1201, the generation unit 203 selects a class of interest from the classes included in the category of interest. For example, in the example in FIG. 11, if the category of interest is “species”, the class of interest is determined from “horse”, “zebra”, “donkey”, or “other”.

In S1202, the generation unit 203 determines whether a class of interest meets a condition for being subject to association processing. The “condition” here is that the percentage of training images belonging to the class of interest of all the training images is at least a predetermined value. For example, if the predetermined value is 5%, in the example in FIG. 11, the classes of “zebra”, “donkey”, and “other” in the category of “species” are determined not to satisfy the condition. In CNN-based machine learning, even if an image is included in the training images, the image may not have a sufficient impact on the performance of the CNN. Accordingly, the determination in S1202 is made with the intention of ensuring that training images in a low-impact class are not selected as the target image. If the generation unit 203 determines that the class of interest meets the condition for being subject to the association processing (YES in S1202), the sequence moves to S1203. However, if the generation unit 203 determines that the class of interest does not meet the condition for being subject to the association processing (NO in S1202), the sequence moves to S1205.

In S1203, the generation unit 203 determines a training image, in the corresponding image group, that has been categorized into a class of interest as the target image. The target image may be any training image that has been categorized into a class of interest. For example, in FIG. 11, if the category of interest is “species” and the class of interest is “horse”, any of the 49,000 training images categorized into that class may be used as the target image. In S1204, the generation unit 203 additionally selects an icon image, from the icon images recorded in the recording medium 157, that corresponds to the class of interest selected in S1201 as a further target image. Additionally, if an icon image corresponding to a plurality of classes in the category of interest is selected as the target image, an icon image that covers that plurality of classes may be selected. For example, in the example in FIG. 11, if the category of interest is “hair color”, all the classes of “bay hair”, “black hair”, “chestnut hair”, and “other color hair” meet the conditions for being subject to association processing. Accordingly, an icon image that represents a class of all the colors of hair may be selected instead of icon images corresponding to the individual classes.

In S1205, the generation unit 203 determines whether a class that has not been selected as a class of interest in the category determined as the category of interest in S1200 is present. If the generation unit 203 determines that a class that has not been selected as a class of interest is present (YES in S1205), the sequence returns to S1201, and the foregoing processing is repeated. However, if the generation unit 203 determines that a class that has not been selected as the class of interest is not present (NO in S1205), the sequence moves to S1206. In S1206, the generation unit 203 determines whether a category that has not been selected as the category of interest is present in the object categorization results obtained in S1000 to S1004. If the generation unit 203 determines that a category that has not been selected as the category of interest is present (YES in S1206), the sequence returns to S1200, and the foregoing processing is repeated. However, if the generation unit 203 determines that a category that has not been selected as the category of interest is not present (NO in S1206), the sequence ends.

As described above, according to the third embodiment, the training images and icon images corresponding to all categories and all classes that meet the condition for being subject to the association processing are selected as target images. Because icon images can express many dictionary characteristics within the narrow display range of the display 150, it is desirable that all icon images that meet the conditions for the association processing be selected as target images. However, when the display range is limited, the determination in S1206 may be changed to a method that determines whether an ending condition is met, such as the determination made in S605 in the first and second embodiments. In this case, it is desirable to prioritize categories and classes that meet predetermined criteria in the selection of the target image. For example, in the processing of selecting the first target image, it is desirable to prioritize a category having a large number of classes that meet the condition in S1202, and furthermore, to prioritize a class, among the classes belonging to that category, having a large number of categorized training images. In the processing of selecting the second and subsequent target images, it is desirable to prioritize a category having a small number of classes that meet the condition for processing in S1202, and furthermore, to prioritize a class, among the classes belonging to that category, having a small number of categorized training images. According to such criteria, representative images (the training image and the icon image) are easily selected in the selection of the first target image, and special images (the training image and the icon image) are easily selected in the selection of the second or subsequent target image.

### (Example of Display of Dictionary Characteristics)

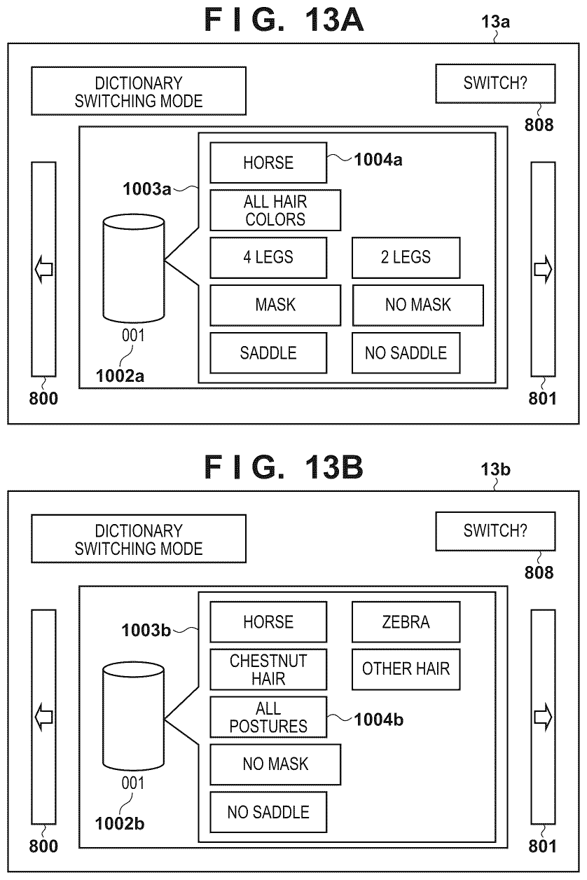

The dictionary characteristics can be displayed using the training image determined as the target image in S1203 described above. An example of the display in this case is the same as in the first embodiment (FIGS. 8A and 8B). On the other hand, in the third embodiment, the dictionary characteristics can be displayed using the icon image determined as the target image in S1204. FIGS. 13A and 13B are diagrams illustrating an example of the display of the switching screen displayed on the display 150 by the switching control unit 201 in S504 according to the third embodiment. FIGS. 13A and 13B illustrate an example of the display expressing the dictionary characteristics using icon images, according to the third embodiment. It should be noted that the display expressing the dictionary characteristics using training images, illustrated in FIGS. 8A and 8B, and the display expressing the dictionary characteristics using icon images, illustrated in FIGS. 13A and 13B, may be switched and displayed as desired by the user.

FIG. 13A will be described first. In a switching screen 13a, the items 800 and 801 and the switching button 808 are the same as those in the first embodiment (FIGS. 8A and 8B). An item 1002a is the ML dictionary to be displayed, and is indicated by “001”, which is the filename of that ML dictionary recorded in the recording medium 157. An area 1003a is an area expressing the dictionary characteristics, and a plurality of icon images expressing the dictionary characteristics, represented by an icon image 1004a, are displayed therein. The icon image 1004a is an example of the icon image selected as the target image in S1204. In the target image selection processing according to the third embodiment, the icon images corresponding to all categories and all classes are determined, without any limitations on the number of images, and thus the characteristics of the dictionary can therefore be expressed more comprehensively. FIG. 13B is an example of a switching screen 13b that displays dictionary characteristics for an ML dictionary that is different from the switching screen 13a, according to the third embodiment. An icon image 1004b indicating “all postures” in the area 1003a is an icon image that collectively represents all the classes of “standing on four legs”, “standing on two legs”, “prone”, and “sleeping” in FIG. 11. Note that the icon image may be an image that enables the user to understand the class, such as a character string indicating the class, a graphic or a photograph indicating the class, or the like, as illustrated in FIGS. 13A and 13B.

As described above, according to the third embodiment, a plurality of icon images are displayed, and by confirming those images, the user can select the ML dictionary to be applied having understood, in advance, the overall dictionary characteristics.

### Fourth Embodiment

### (Overall Configuration)

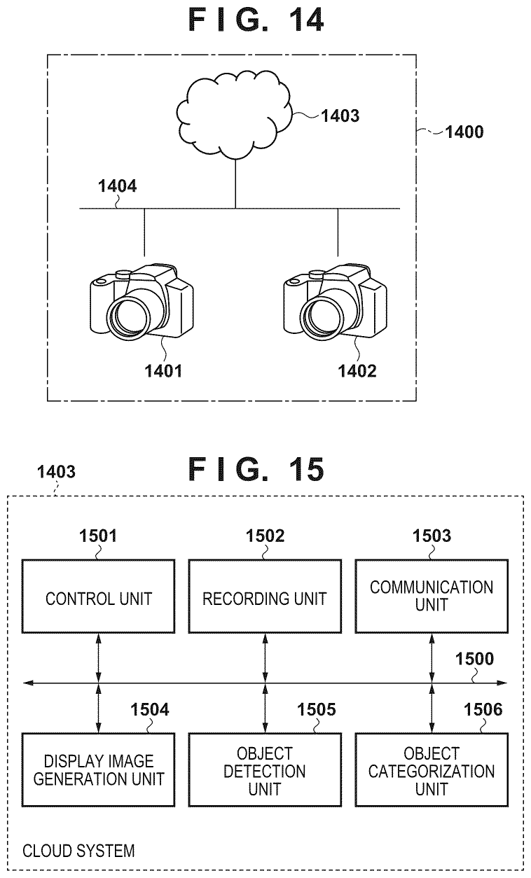

The first embodiment to the third embodiment described a configuration in which the characteristic representation of the ML dictionary is obtained by an image processing apparatus (the object detection unit 162, the object categorization unit 163, the dictionary switching unit 164, and the like) within the image capturing apparatus 100. The fourth embodiment will describe a configuration in which the characteristic representation of the ML dictionary is obtained by an external image processing apparatus (e.g., a cloud system) and provided to the image capturing apparatus. FIG. 14 is a diagram illustrating an example of the overall configuration of an image processing system 1400 according to the fourth embodiment. The image processing system 1400 includes an image capturing apparatus 1401, an image capturing apparatus 1402, a cloud system 1403, and a network 1404. The image capturing apparatus 1401, the image capturing apparatus 1402, and the cloud system 1403 are connected to each other in a communication-enabling manner over the network 1404. The specific configurations of the image capturing apparatus 1401 and the image capturing apparatus 1402 are the same as that of the image capturing apparatus 100 according to the first embodiment. However, the dictionary switching unit 164 need not have a function for obtaining the target image for expressing the characteristics of the ML dictionary. The cloud system 1403 is an example of an image processing apparatus capable of communicating with the image capturing apparatus 1401 and the image capturing apparatus 1402. Furthermore, the image processing apparatus serving as the apparatus external to the image capturing apparatus is not limited to the cloud system 1403, and may be implemented by a server apparatus on a LAN, for example.

The image capturing apparatus 1401 is configured in the same manner as the image capturing apparatus 100, is used by a user to shoot training images, and performs machine learning for ML dictionaries applicable in the object detection unit 162. The ML dictionary obtained through machine learning and the plurality of training images used in the machine learning (“corresponding image group” hereinafter) are uploaded to the cloud system 1403 over the network 1404. Although it is desirable that the corresponding image group include all the training images used in the machine learning, training images extracted randomly may be used, to the extent that the effects achieved by the embodiment of the present disclosure are not affected. The image capturing apparatus 1402 has the same configuration as the image capturing apparatus 100, and can utilize an environment provided by the cloud system 1403. For example, the image capturing apparatus 1402 downloads the ML dictionary from the cloud system 1403, applies the dictionary to the object detection unit 162, and uses the object detection function for the captured image. The cloud system 1403 records a plurality of ML dictionaries, and a plurality of training images for each ML dictionary, uploaded by the user. The cloud system 1403 also provides an environment that expresses the performance of the ML dictionary, and in which the user can download a plurality of ML dictionaries. For the sake of convenience, FIG. 14 illustrates one each of the image capturing apparatus 1401 which uploads and the image capturing apparatus 1402 which downloads, but the configuration is not limited thereto. For example, a plurality of ML dictionaries from a plurality of image capturing apparatuses may be uploaded to the cloud system 1403.

### (Configuration of Cloud System)

FIG. 15 is a block diagram illustrating an example of the configuration of the cloud system 1403 according to the fourth embodiment. The various functional units in the cloud system 1403 are connected to each other over a bus 1500. A control unit 1501 controls the various functional units. A recording unit 1502 is a high-capacity recording medium such as an HDD, and the plurality of ML dictionaries uploaded from the image capturing apparatus 1401 and the plurality of ML dictionaries applicable in an object categorization unit 1506 are recorded therein. Training images used in respective instances of machine learning, association information, and the like are also recorded in the plurality of ML dictionaries uploaded from the image capturing apparatus 1401. Icon images corresponding to each category and each class in the object categorization results are also recorded in the ML dictionary applied in the object categorization unit 1506. A communication unit 1503 communicates ML dictionaries, information related to ML dictionaries such as training images, and the like by connecting to the image capturing apparatus 1401 and the image capturing apparatus 1402 over Ethernet or wirelessly.

A display image generation unit 1504 generates display images, and provides a GUI used for uploading and downloading ML dictionaries to the users of the image capturing apparatus 1401 and the image capturing apparatus 1401 via the communication unit 1503. An object detection unit 1505 determines a region in which an object, such as a horse, is present in an image, by applying an ML dictionary recorded in the recording unit 1502. The object detection unit 1505 is constituted by the same CNN as the object detection unit 162 in the image capturing apparatus 1401 and the image capturing apparatus 1402. The object categorization unit 1506 categorizes to which of predetermined classes an object in an image belongs, by applying an ML dictionary recorded in the recording unit 1502. The object categorization unit 1506 is constituted by the same CNN as the object categorization unit 163 in the image capturing apparatus 1401 and the image capturing apparatus 1402.

### (Flow of Overall Processing)

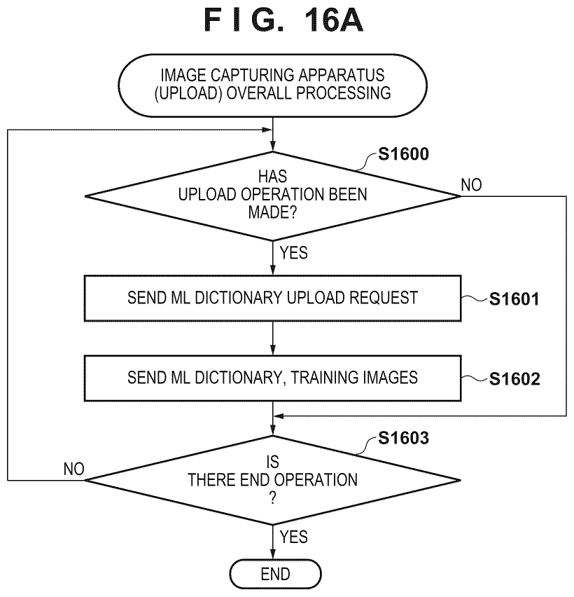

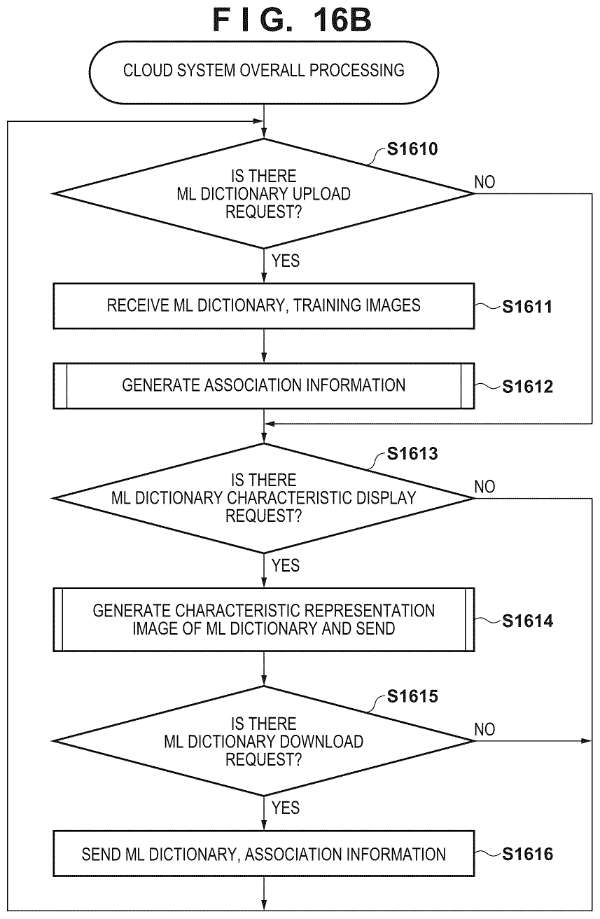

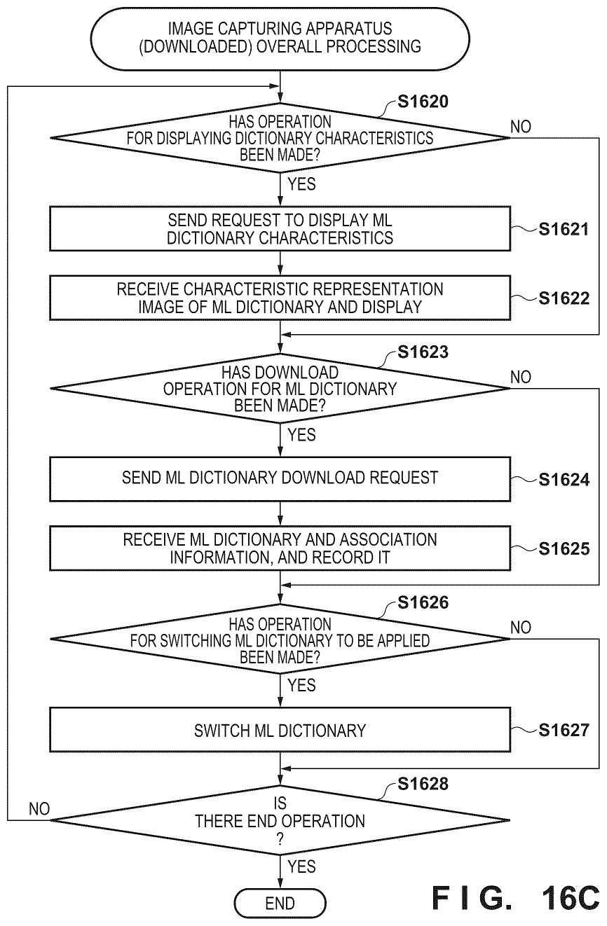

FIGS. 16A to 16C are flowcharts illustrating overall processing performed by the cloud system 1403 according to the fourth embodiment. Processing performed by the image capturing apparatus 1401, the cloud system 1403, and the image capturing apparatus 1402 will be described with reference to FIGS. 16A, 16B, and 16C, respectively.

FIG. 16A is a flowchart illustrating the overall processing performed by the image capturing apparatus 1401 according to the fourth embodiment. In S1600, the switching control unit 201 determines whether an operation for uploading an ML dictionary has been made by the user through the operation switch 156. If the switching control unit 201 determines that an upload operation has been made (YES in S1600), the sequence moves to S1601, whereas if the switching control unit 201 determines that an upload operation has not been made (NO in S1600), the sequence moves to S1603.

In S1601, the switching control unit 201 makes an upload request to the cloud system 1403, which is an external apparatus, through the communication unit 161. Next, in S1602, the switching control unit 201 sends the ML dictionary recorded in the recording medium 157 and the plurality of training images used in the training of the ML dictionary to the cloud system 1403 through the communication unit 161. In S1603, the switching control unit 201 determines whether an ending instruction has been made by the user through the operation switch 156. If the switching control unit 201 determines that no ending instruction has been made (NO in S1603), the sequence returns to S1600, and the foregoing processing is repeated. However, if the switching control unit 201 determines that an ending instruction has been made (YES in S1603), the sequence ends.

FIG. 16B is a flowchart illustrating overall processing performed by the cloud system 1403 according to the fourth embodiment. First, in S1610, the control unit 1501 determines whether an ML dictionary upload request has been made from an external apparatus (the image capturing apparatus 1401, in this example) through the communication unit 1503. If the control unit 1501 determines that an upload request has been made (YES in S1610), the sequence moves to S1611. However, if the control unit 1501 determines that no upload request has been made (NO in S1610), the sequence moves to S1613.

In S1611, the control unit 1501 receives, through the communication unit 1503, the ML dictionary and the plurality of training images used to train the ML dictionary from the image capturing apparatus 1401 that made the upload request, and records those items in the recording unit 1502. In S1612, the control unit 1501 reads out the ML dictionary and the plurality of training images used to train the ML dictionary, recorded in the recording unit 1502 in S1611, and generates the association information. The details of the processing for generating the association information in S1612 are similar to those in the first embodiment or the second embodiment (S503), with the exception that the processing is executed by the corresponding units in the cloud system 1403.

In S1613, the control unit 1501 determines whether a request to display the ML dictionary characteristics has been made from an external apparatus (the image capturing apparatus 1402, in this example) through the communication unit 1503. If the control unit 1501 determines that the display request has been made (YES in S1613), the sequence moves to S1614, whereas if the control unit 1501 determines that no display request has been made (NO in S1613), the sequence returns to S1610. In S1614, the display image generation unit 1504 generates a characteristic representation image expressing the characteristics of the ML dictionary, on the basis of the association information generated in S1612, the ML dictionary, and the plurality of training images corresponding to the ML dictionary. The display image generation unit 1504 then sends the generated characteristic representation image to the image capturing apparatus 1402 from which the display request was made, through the communication unit 1503. Note that the details of the processing performed in S1614 are similar to those in the first embodiment or the second embodiment (S504), with the exception that the processing is executed by the corresponding units in the cloud system 1403.

In S1615, the control unit 1501 determines whether a request to download the ML dictionary has been received from an external apparatus (the image capturing apparatus 1402, in this example) through the communication unit 161. If the control unit 1501 determines that a download request has been received (YES in S1615), the sequence moves to S1616, whereas if the control unit 1501 determines that a download request has not been received (NO in S1615), the sequence returns to S1610. In S1616, the control unit 1501 sends the ML dictionary, among the plurality of ML dictionaries recorded in the recording unit 1502, the ML dictionary expressing the dictionary characteristics in S1614, and the association information generated in S1612 for that ML dictionary, to the image capturing apparatus 1402 that made the download request, through the communication unit 1503.

FIG. 16C is a flowchart illustrating the overall processing performed by the image capturing apparatus 1402 according to the fourth embodiment. In S1620, whether an operation for displaying the dictionary characteristics has been made by the user through the operation switch 156 is determined. If the switching control unit 201 determines that the display operation has been made (YES in S1620), the sequence moves to S1621, whereas if the switching control unit 201 determines that no display operation has been made (NO in S1620), the sequence moves to S1623.

In S1621, the switching control unit 201 sends an ML dictionary characteristic display request to the cloud system 1403, which is an external apparatus, through the communication unit 161. In S1622, the switching control unit 201 receives a characteristic representation image of the ML dictionary from the cloud system 1403 via the communication unit 161, and displays the characteristic representation image on the display 150. The characteristic representation image is the same as the example of the display of the switching screen illustrated in the first embodiment (FIGS. 8A and 8B), for example.

In S1623, the switching control unit 201 determines whether a download operation for the ML dictionary for which the characteristics have been expressed in the characteristic representation image has been made by the user through the operation switch 156. If the switching control unit 201 determines that a download operation has been made (YES in S1623), the sequence moves to S1624, whereas if the switching control unit 201 determines that no download operation has been made (NO in S1623), the sequence moves to S1626. In S1624, the switching control unit 201 sends an ML dictionary download request to the cloud system 1403, which is an external apparatus, through the communication unit 161. In S1625, through the communication unit 161, the switching control unit 201 receives the ML dictionary and the association information (e.g., the target image) generated for the ML dictionary from the cloud system 1403, and records the association information (e.g., the target image) in the recording medium 157.

In S1626, the switching control unit 201 determines whether an operation for switching the ML dictionary, recorded in the recording medium 157 in S1625, to be applied in the object detection unit 162 has been made by the user through the operation switch 156. If the switching control unit 201 determines that the switching operation has been made (YES in S1626), the sequence moves to S1627, whereas if the switching control unit 201 determines that the switching operation has not been made (NO in S1626), the sequence moves to S1628. In S1627, the switching control unit 201 switches the ML dictionary applied in the object detection unit 162 on the basis of the switching operation made by the user. Thereafter, object detection processing using the ML dictionary switched to in S1627 can be performed on through-the-lens images, captured images, and the like in the image capturing apparatus 1402. In S1628, the switching control unit 201 determines whether an ending instruction has been made by the user through the operation switch 156. If the switching control unit 201 determines that an ending instruction has been made (YES in S1628), the sequence ends. However, if the switching control unit 201 determines that no ending instruction has been made (NO in S1628), the sequence returns to S1620, and the foregoing processing is repeated.

As described above, according to the fourth embodiment, an image capturing apparatus can obtain, from a cloud system, training images having representative features and special features as information expressing the characteristics of an ML dictionary to be displayed, and can display the training images. Accordingly, by confirming those images, the user of the image capturing apparatus can download and apply the ML dictionary having understood, in advance, the overall dictionary characteristics, without placing a load on the image capturing apparatus.

Although the configuration according to the first embodiment or the second embodiment is employed as the configuration for the association information generation processing in S1612 and the obtainment of the characteristic representation image in S1614 (S1622), the configuration is not limited thereto. The configuration of the third embodiment may be employed as the configuration for the association information generation processing in S1612 and the obtainment of the characteristic representation image in S1614 (S1622). In this case, the processing for generating the association information in S1612 is similar to that of the third embodiment (FIGS. 10 and 12), with the exception that the processing is executed by the corresponding units in the cloud system 1403. The characteristic representation image of the ML dictionary generated by the cloud system 1403 in S1614, received through the communication unit 161 of the image capturing apparatus 1402 in S1622, and displayed is the same as the example described with reference to FIGS. 13A and 13B in the third embodiment.

As described above, according to the fourth embodiment, icon images are displayed by the cloud system, and by confirming those images, the user can download and apply the ML dictionary having understood, in advance, the overall dictionary characteristics, without placing a load on the image capturing apparatus.

According to one aspect of the present disclosure, information enabling a user to understand the characteristics of a dictionary obtained through machine learning can be generated.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. An image processing apparatus comprising:
an obtaining unit configured to obtain a dictionary obtained through machine learning and a plurality of training images used in the machine learning of the dictionary;
a selecting unit configured to select from the plurality of training images, at least one training image to be used as information expressing a characteristic of the dictionary; and
a generating unit configured to generate association information that associates the at least one training image selected by the selecting unit with the dictionary.

2. The image processing apparatus according to claim 1, wherein the selecting unit selects the at least one training image on the basis of a plurality of feature vectors obtained from the plurality of training images.

3. The image processing apparatus according to claim 2, further comprising:
a detecting unit configured to detect an object from an image using one of a plurality of dictionaries obtained through machine learning,
wherein as the plurality of feature vectors, the selecting unit obtains intermediate data obtained from the detecting unit as a result of inputting the plurality of training images into the detecting unit.

4. The image processing apparatus according to claim 2, wherein the selecting unit selects a training image having a feature vector, among the plurality of feature vectors, having a smallest distance from an average vector that is an average of the plurality of feature vectors.

5. The image processing apparatus according to claim 2, wherein the selecting unit selects a predetermined number of feature vectors from the plurality of feature vectors in order from a feature vector having a greatest distance from an average vector that is an average of the plurality of feature vectors, and selects a predetermined number of training images corresponding to the predetermined number of feature vectors.

6. The image processing apparatus according to claim 4, wherein the selecting unit selects a predetermined number of feature vectors from the plurality of feature vectors in order from a feature vector having a greatest difference from the feature vector having the smallest distance from the average vector, and selects a predetermined number of training images corresponding to the predetermined number of feature vectors.

7. The image processing apparatus according to claim 3, wherein the selecting unit selects the at least one training image from training images satisfying a condition that the detecting unit is capable of detecting an object from the training image using the dictionary.

8. The image processing apparatus according to claim 2, wherein the selecting unit selects the at least one training image from training images satisfying a condition that other training images having a feature vector for which a distance from an obtained feature vector is smaller than a predetermined value occupy at least a predetermined percentage of the plurality of training images.

9. The image processing apparatus according to claim 1, further comprising:
a display information generating unit configured to generate display information for displaying the dictionary and the at least one training image in association with each other on the basis of the association information.

10. The image processing apparatus according to claim 1, further comprising:
a categorizing unit configured to categorize the plurality of training images into a plurality of classes,
wherein the selecting unit selects the training image on the basis of a categorizing result obtained as a result of inputting the plurality of training images into the categorizing unit.

11. The image processing apparatus according to claim 10, wherein the selecting unit selects a training image belonging to a class, among the plurality of classes, into which a greatest number of training images have been categorized in the categorizing result.

12. The image processing apparatus according to claim 10, wherein the selecting unit selects a predetermined number of training images from a predetermined number of classes, among the plurality of classes, selected in order from a class having a smallest number of training images categorized in the categorizing result.

13. The image processing apparatus according to claim 10, wherein the selecting unit selects the at least one training image from training images belonging to a class in which a ratio of a total number of categorized training images to a total number of the plurality of training images is at least a predetermined value.

14. The image processing apparatus according to claim 10, wherein:
the selecting unit further selects at least one icon image, from a plurality of icon images corresponding to the plurality of classes, that corresponds to a class to which each of the at least one training images belongs, and
the generating unit includes information associating the dictionary with the at least one icon image in the association information.

15. The image processing apparatus according to claim 14, further comprising:
a display information generating unit configured to generate display information for displaying the dictionary and the at least one training image or the at least one icon image in association with each other on the basis of the association information.

16. An image processing apparatus comprising:
an obtaining unit configured to obtain a dictionary obtained through machine learning and a plurality of training images used in the machine learning of the dictionary;
a categorizing unit configured to categorize the plurality of training images into a plurality of classes;
a selecting unit configured to select at least one icon image, from a plurality of icon images corresponding to the plurality of classes, to be used as information expressing a characteristic of the dictionary, on the basis of a result of the categorizing unit categorizing the plurality of training images; and
a generating unit configured to generate association information that associates the at least one icon image selected by the selecting unit with the dictionary.

17. The image processing apparatus according to claim 1, further comprising:
a receiving unit configured to receive the dictionary and the plurality of training images from an external apparatus; and
a sending unit configured to send the dictionary and the association information to the external apparatus.

18. An image capturing apparatus comprising:
an image capturing unit;
the image processing apparatus according to claim 1;
a switching unit configured to switch, in response to a user operation, a dictionary to be applied in detecting unit that detects an object from an image captured by the image capturing unit; and
a display unit configured to display a characteristic of the dictionary switched to by the switching unit on the basis of the association information.

19. An image capturing apparatus comprising:
an image capturing unit;
a communicating unit configured to communicate with the image processing apparatus according to claim 17;
a switching unit configured to switch, in response to a user operation, a dictionary to be applied in detecting unit that detects an object from an image captured by the image capturing unit; and
a display unit configured to display a characteristic of the dictionary switched to by the switching unit on the basis of the association information, the association information being received from the image processing apparatus by the communicating unit.

20. A control method of an image processing apparatus, the control method comprising:
obtaining a dictionary obtained through machine learning and a plurality of training images used in the machine learning of the dictionary;
selecting, from the plurality of training images, at least one training image to be used as information expressing a characteristic of the dictionary; and
generating association information that associates the selected training image(s) with the dictionary.

21. A control method of an image processing apparatus, the control method comprising:
obtaining a dictionary obtained through machine learning and a plurality of training images used in the machine learning of the dictionary;
categorizing the plurality of training images into a plurality of classes;
selecting at least one icon image, from a plurality of icon images corresponding to the plurality of classes, to be used as information expressing a characteristic of the dictionary, on the basis of a result of the plurality of training images being categorized in the categorizing step; and
generating association information that associates the at least one icon image selected in the selecting step with the dictionary.

22. A non-transitory computer-readable storage medium which stores a program for causing a computer to execute the method according to claim 20.
